(19) United States
(12) Patent Application Publication
(10) Pub. No.: US 2006/0220531 A1
(43) Pub. Date: Oct. 5, 2006

(54) Semiconductor light emitting apparatus

(75) Inventors: Seiichi Tokunaga, Osaka (JP); Takeshi Sano, Osaka (JP); Kunimoto Ninomiya, Osaka (JP)

Correspondence Address: NDQ&M WATCHSTONE LLP, 1300 EYE STREET, NW, 400 EAST TOWER, WASHINGTON, DC, 20005, US

(73) Assignee: Sanyo Electric Co., Ltd., Moriguchi-shi (JP)

(21) Appl. No.: 11/389,029

(22) Filed: Mar. 27, 2006

(30) Foreign Application Priority Data
Mar. 30, 2005 (JP) JP2005-099927

(51) Int. Cl. H01J 1/62; H01J 63/04

(52) U.S. Cl. 313/501

(57) ABSTRACT

A semiconductor light emitting apparatus includes a packaging member, a light-emitting element mounted in the packaging member and a wavelength changer. The wavelength changer which absorbs the light from the light-emitting element and emits a wavelength-converted light. The wavelength changer includes inorganic fluorescent material and organic fluorescent material.

### CROSS REFERENCE TO RELATED APPLICATIONS

This application is based upon and claims the benefit of priority from prior Japanese Patent Application P2005-099927 filed on Mar. 30, 2005; the entire contents of which are incorporated by reference herein.

### BACKGROUND OF THE INVENTION

1. Field of the Invention

The present invention relates to a semiconductor light emitting apparatus that includes a packaging member, a light-emitting element mounted in the packaging member, and a wavelength changer which absorbs the light from the light-emitting element and emits a wavelength-converted light.

2. Description of the Related Art

Conventionally, white LED has been developed that uses a technique for using fluorescent material to convert a wavelength of light emitted from a light-emitting diode (LED) chip. This white LED also has been expected to be used for a lighting application and thus has required high color rendering property and high reliability. The term “high color rendering property” herein means a property having an emission spectrum close to that of daylight and the term “reliability” means a property by which the characteristic is suppressed form being deteriorated even in the case of the use for a long time.

Currently, inorganic materials are generally used as fluorescent material for white LED and have various types and combinations with LED chips. Such combinations include, for example, a combination of blue light-emitting LED chip and yellow and red fluorescent materials and a combination of an ultraviolet emission LED chip and blue, green, and red fluorescent materials (see Japanese Patent Publication No. 3486345 for example).

The above-described inorganic fluorescent material is advantageous in that the temporal deterioration is small (i.e., the reliability is high). However, the inorganic fluorescent material has difficulty in the preparation of red fluorescent material that has an emission spectrum as broad as those of blue and green fluorescent materials for example. This difficulty causes a problem where white LED prepared by the material has a small color rendering property.

To solve this problem, the use of organic material as fluorescent material for white LED has been tried. Organic materials include a great number of red fluorescent materials having broad emission spectra. Thus, such red fluorescent materials can be combined with organic fluorescent materials showing other light emissions to prepare a white LED having a high color rendering property.

However, in many organic fluorescent materials, the emission property (reliability) deteriorates as time passes because of irradiating light from the LED chip and heat generation during the light emission for example. This causes a problem where light emitted from the white LED changes or the brightness is reduced for example.

In view of the above, it is an objective of the present invention to provide a semiconductor light emitting apparatus that provides both of high color rendering property and high reliability.

### SUMMARY OF THE INVENTION

A first aspect of the present invention is to provide a semiconductor light emitting apparatus including a packaging member and a light-emitting element mounted in the packaging member, including: a wavelength changer which absorbs the light from the light-emitting element and emits a wavelength-converted light, wherein the wavelength changer includes inorganic fluorescent material and organic fluorescent material.

### BRIEF DESCRIPTION OF DRAWINGS

FIG. 1 is a cross-sectional view illustrating a semiconductor light emitting apparatus according to a first embodiment.

FIG. 2 illustrates an emission spectrum of a semiconductor light emitting apparatus according to example 1.

FIG. 3 is a cross-sectional view illustrating a semiconductor light emitting apparatus according to a second embodiment.

FIG. 4 is a cross-sectional view illustrating a semiconductor light emitting apparatus according to comparative example 1.

FIG. 5 illustrates an emission spectrum of the semiconductor light emitting apparatus according to comparative example 1.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

### First Embodiment

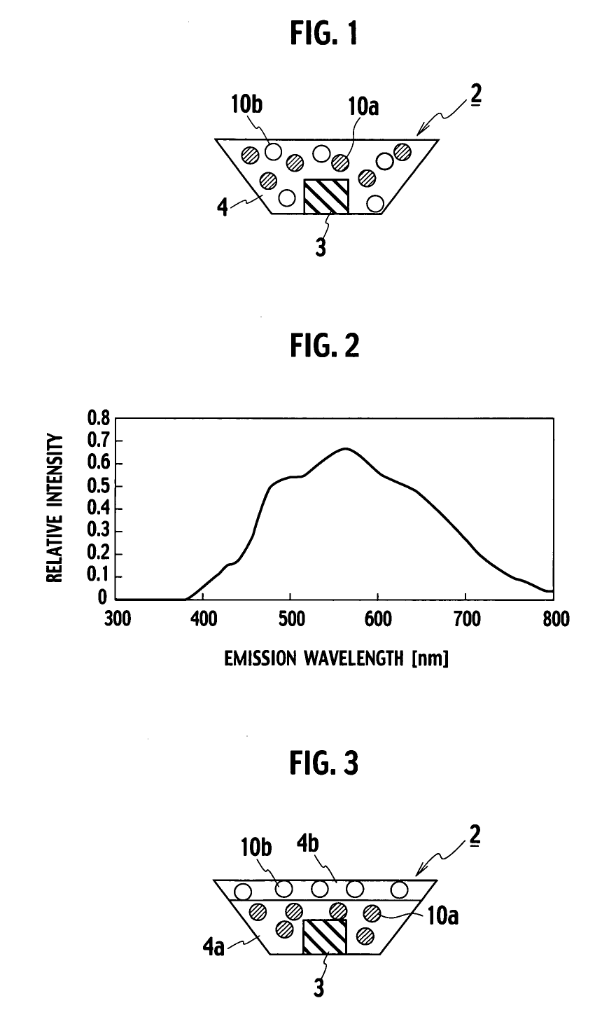

As shown in FIG. 1, a semiconductor light emitting apparatus (white LED apparatus) according to a first embodiment includes a packaging member (cup) 2 and a light-emitting element (LED chip) 3 mounted in the packaging member (cup) 2. On the light-emitting element 3, a translucent resin 4 is provided that includes an inorganic fluorescent material 10a and an organic fluorescent material 10b and is cured. It is noted that a wiring for mounting the light-emitting element 3 for example is omitted in FIG. 1.

Next, materials constituting the semiconductor light emitting apparatus according to the first embodiment will be exemplarily described. However, the present invention is not limited to these materials.

When white light is emitted by the light-emitting element 3, the light-emitting element 3 preferably has an emission wavelength in a range from 350 nm to 420 nm in consideration of a complementary color relation with an emission wavelength from the fluorescent material and deterioration of translucent resin for example.

The kind of the inorganic fluorescent material 10a is not particularly limited. The inorganic fluorescent material 10a may be selected from, for example, BaMg₂Al₁₆O₂₇: Eu, SrCaBa₅ (PO₄)₃Cl: Eu, BaSi₂O₅: Pb, YPO₄: Ce, Sr₂P₂O₇: or Eu, ZnS: Cu, Al.

The kind of the organic fluorescent material 10b is not particularly limited. The organic fluorescent material 10b may be selected from, for example, sodium salicylate, eosin, anthracene, diaminostilbene derivative, terphenyl, Lumogen, and coronen. The organic fluorescent material 10b preferably emits red light.

The translucent resin 4 may be the one that can include fluorescent material and preferably includes, for example, thermosetting epoxy resin (e.g., alicyclic epoxy resin, nitrogen-containing epoxy resin). However, the translucent resin 4 is not limited to this and also may be selected from other epoxy resin and silicon resin or the like. It is noted that these translucent resins also may include various additive agents, including: colorant for cutting a desired wavelength; titanic oxide for diffusing desired light; inorganic diffusion material (e.g., aluminum oxide); organic diffusion material (e.g., melanin resin, guanamine resin, benzguanamine resin); ultraviolet absorber for improving the light resistance of resin; antioxidant; or hardening accelerator (e.g., organic carboxylic acid zinc, acid anhydride, zinc chelate compound).

Other materials are already known and thus will not be described.

A method for preparing the semiconductor light emitting apparatus according to the first embodiment will be described.

The inorganic fluorescent material 10a and the organic fluorescent material 10b in appropriate amounts are mixed and are dispersed in the translucent resin 4. The translucent resin 4 may use epoxy-base or silicon-base material for example as described above so long as the inorganic fluorescent material 10a and the organic fluorescent material 10b can be dispersed in the translucent resin. Then, fluorescent material-containing resin is prepared by a known method, the light-emitting element 3 is provided, and the fluorescent material-containing resin is coated and cured on the packaging member 2. Thereafter, a conventional method is used to prepare a LAMP Type LED.

In the first embodiment, the inorganic fluorescent material 10a and the organic fluorescent material 10b are placed on the same light-emitting element 3 to prepare a white LED apparatus. As a result, high color rendering property and high reliability can be simultaneously provided.

Organic fluorescent materials include a great number of red fluorescent materials having broad emission spectra. The use of red fluorescent material of organic material provides a smooth spectrum of a long wavelength region of a visible part, providing white light emission having high color rendering property.

Furthermore, light emitted from the light-emitting element 3 has a peak wavelength ranging from 350 nm to 420 nm. Thus, high color rendering property and high reliability can be simultaneously provided more effectively. This effect is remarkable particularly when the light from the light-emitting element has a shorter peak wavelength (e.g., when the light-emitting element uses a GaN-base semiconductor).

### Second Embodiment

As shown in FIG. 3, a semiconductor light emitting apparatus (white LED apparatus) according to a second embodiment includes the packaging member (cup) 2 and the light-emitting element (LED chip) 3 mounted in the packaging member (cup) 2. An inorganic fluorescent material-containing resin layer 4a including the inorganic fluorescent material 10a is provided at a position to surround the periphery of the light-emitting element 3 and is cured. An organic fluorescent material-containing resin layer 4b including the organic fluorescent material 10b is provided and cured on the inorganic fluorescent material-containing resin layer 4a. It is noted that a wiring for mounting the light-emitting element 3 for example is omitted in FIG. 3.

The organic fluorescent material 10b preferably emits red light. Furthermore, light emitted from the light-emitting element 3 preferably has a peak wavelength from 350 nm to 420 nm.

Materials constituting the semiconductor light emitting apparatus according to the second embodiment are the same as those in the first embodiment and thus will not be described.

A method for preparing the semiconductor light emitting apparatus according to the second embodiment will be described.

The inorganic fluorescent material 10a in an appropriate amount is mixed and is dispersed in the translucent resin 4. The translucent resin 4 may use epoxy-base or silicon-base material for example as described above so long as the inorganic fluorescent material 10a can be dispersed in the translucent resin. Next, the inorganic fluorescent material-containing resin 4a is prepared by a known mehod, the light-emitting element 3 is provided, and the inorganic fluorescent material-containing resin 4a is coated and cured on the wired packaging member 2.

On the other hand, the organic fluorescent material 10b in an appropriate amount is mixed and is dispersed in the translucent resin 4b. The translucent resin 4b may use epoxy-base or silicon-base material for example so long as the organic fluorescent material 10b can be dispersed in the translucent resin. The organic fluorescent material-containing resin 4b is prepared by a known mehod, the light-emitting element 3 is provided, and the organic fluorescent material-containing resin 4b is coated and cured on the wired packaging member 2. Thereafter, a conventional method is used to prepare a LAMP Type LED.

The respective curings of the translucent resin may be divided into two steps or also may be performed in one step. A position at which the organic fluorescent material-containing resin 4b is placed need not be the one just above the inorganic fluorescent material-containing resin 4a as shown in FIG. 3 and may be any position so long as the position provides color conversion.

In the second embodiment, the coating of the inorganic fluorescent material-containing resin 4a is followed by the coating of the organic fluorescent material-containing resin 4b to allow the organic fluorescent material 10b to be positioned away from the light-emitting element 3. Thus, the organic fluorescent material 10b can be prevented from having temporal deterioration of the emission property due to light emission from the light-emitting element 3 and heat generation during the light emission for example.

The use of red fluorescent material of organic material provides a smooth spectrum of a long wavelength region of a visible part, providing white light emission having high color rendering property.

Furthermore, light emitted from the LED chip 3 has a peak wavelength ranging from 350 nm to 420 nm. Thus, high color rendering property and high reliability can be simultaneously provided more effectively.

### Other Embodiments

The present invention has been described according to the foregoing first to the second embodiments. However, it should be understood that the description and drawings which partially constitute the present disclosure do not limit this invention. From this disclosure, various alternative embodiments, embodiments and operational technologies will become apparent to those skilled in the art.

For example, although Embodiments 1 and 2 have exemplarily described the white LED apparatus, the present invention is not limited to this. The present invention also can be used for the preparation of a light-emitting element combined with fluorescent material that uses light emitted form a light-emitting element as excitation light.

Materials for a substrate used in the light-emitting element 3 are not particularly limited and may be GaN, AlGaN, InGaN, AlN, sapphire or the like depending on an application.

Various modifications will become possible for those skilled in the art after receiving the teachings of the present disclosure without departing from the scope thereof.

### EXAMPLES

Hereinafter, a white LED apparatus according to the present invention will be specifically described by exemplary examples and how to simultaneously provide high color rendering property and high reliability will be described by comparative examples. It is noted that the white LED apparatus according to the present invention is not limited to those shown in the following exemplary examples and can be appropriately changed and practiced within a range not changing the intention.

### Example 1

In example 1, an organic fluorescent material-containing resin and an inorganic fluorescent material-containing resin were prepared and were coated and cured on a LED chip as shown below, thereby preparing a white LED apparatus as shown in FIG. 1. Here, a LED chip used a GaN-base substrate and a peak of the emission wavelength was 390 nm.

[Process 1: Preparation of Organic Fluorescent Material-containing Resin]

Organic fluorescent material of 25 mg was dispersed in toluene of 5 ml to prepare organic fluorescent material mixed with toluene. In order to sufficiently disperse the fluorescent material, a stirrer was used to perform processings such as stirring and heating. The heating temperature was 50 degrees. Next, the prepared organic fluorescent material mixed with toluene was mixed with 5 ml of silicon-base resin and was stirred with revolution of 2000 rpm and rotation of 800 rpm for 5 minutes. Thereafter, vacuuming using a rotary pump was performed to provide defoaming for 10 minutes. It is noted that the stirring operation also may use a method by physical stirring by blades and the defoaming operation also may use a known method such as a revolution method.

The organic fluorescent material used here is poly[(9,9-dihexylfluorene2,7-diyl)-alto{2,5-bis(N,N′-diphenylamino)-1,4-bis(1-cyanovinylene)phenylene}] (PF6-CVAP) and emits red light and has an emission spectrum having a broad peak in a long optical wavelength region.

First, the operation for mixing organic fluorescent material in toluene was performed. This operation intends to prevent the organic fluorescent material from being deteriorated in atmospheric air and was performed in nitrogen atmosphere. It is noted that this operation may be performed not only in nitrogen atmosphere but also in another atmosphere (e.g., vacuum) so long as the atmosphere can exclude active gas. Another appropriate solution other than toluene (e.g., acetone) also may be used.

[Process 2: Preparation of Inorganic Fluorescent Material-containing Resin]

The total amount of 250 mg of inorganic fluorescent material was dispersed in 1 ml of silicon-base resin as in Process 1. In order to sufficiently disperse the fluorescent material, stirring and defoaming were performed based on the same conditions as those in Process 1.

The inorganic fluorescent material used here was known blue fluorescent material and green fluorescent material that were mixed with a mixing ratio of 2:8 of the blue fluorescent material and the green fluorescent material in this order. Both of the fluorescent materials have broad emission spectra.

[Process 3: Preparation of Organic Fluorescent Material and Inorganic Fluorescent Material-containing Resin]

The organic fluorescent material-containing resin of 0.3 ml prepared in Process 1 and the inorganic fluorescent material-containing resin of 1.0 ml prepared in Process 2 were mixed to prepare organic fluorescent material and the inorganic fluorescent material-containing resin. In order to disperse the organic fluorescent material and the inorganic fluorescent material, stirring and defoaming were performed based on the same conditions as those in Process 1.

[Process 4: Coating and Curing on LED Chip]

The organic fluorescent material and the inorganic fluorescent material-containing resin prepared in Process 3 were injected into a cup electrically connected with a LED chip by a known method. By controlling the injection amount, the organic fluorescent material and the inorganic fluorescent material-containing resin were injected into the entire cup. The injected resin protruded in an upward direction of the cup. Thereafter, the resin was subjected to heat treatment with 120 degrees for 3 hours to cure the resin.

[Process 5: Preparation of LAMP Type LED]

Thereafter, a known method was used to prepare a LAMP Type LED with silicon-base resin.

### Example 2

In example 2, inorganic fluorescent material-containing resin was coated on a LED chip and then organic fluorescent material-containing resin was coated and cured as described below, thereby preparing the white LED apparatus as shown in FIG. 3. The LED chip here used a GaN-base substrate and the emission wavelength had a peak of 390 nm.

[Process 1: Preparation of Organic Fluorescent Material-containing Resin]

This was performed as in Process 1 of example 1.

[Process 2: Preparation of Inorganic Fluorescent Material-containing Resin]

This was performed as in Process 2 of example 1.

[Process 3: Coating and Curing of Inorganic Fluorescent Material-containing Resin on LED Chip]

The inorganic fluorescent material-containing resin prepared in Process 2 was injected into a cup electrically connected with a LED chip by a known method. By controlling the injection amount, the upper end of the cup was not covered with the resin. The resin was subjected to heat treatment at 120 degrees for 3 hours to cure the resin.

[Process 4: Coating and Curing of Organic Fluorescent Material-containing Resin on LED Chip]

The organic fluorescent material-containing resin prepared by Process 1 was injected into a cup electrically connected with a LED chip by a known method. By controlling the injection amount, the same condition as that of Process 3 of example 1 was provided. Then, the resin was subjected to heat treatment with 120 degrees for 3 hours to cure the resin.

[Process 5: Preparation of LAMP Type LED]

This was performed in the same manner as that in Process 1 of example 1.

### Comparative Example 1

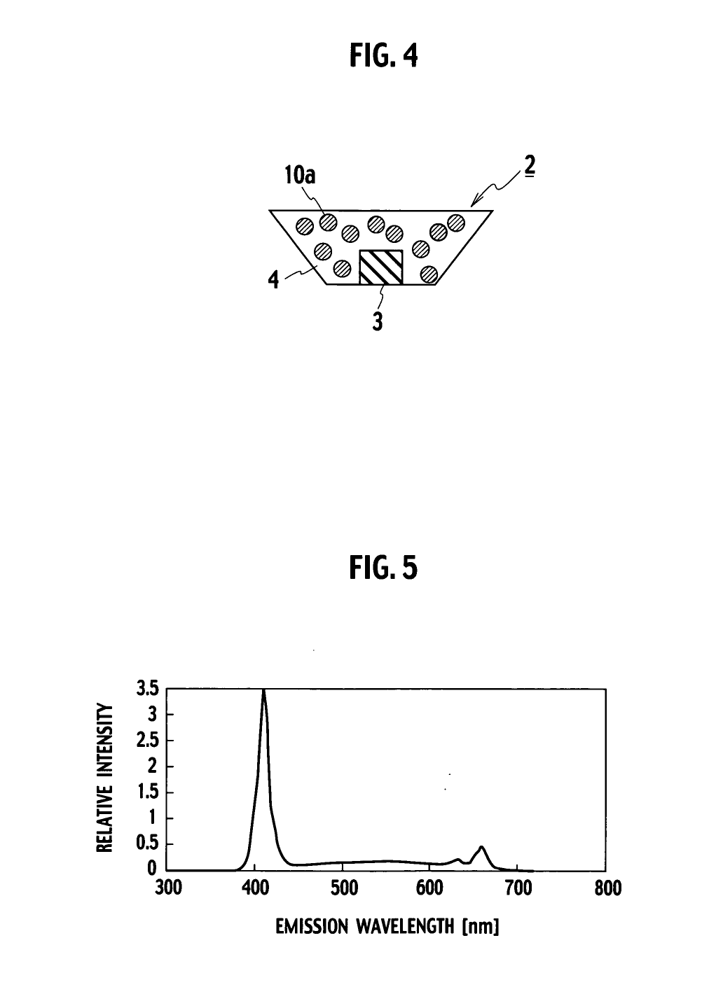

In comparative example 1, only inorganic fluorescent material-containing resin was coated and cured on a LED chip as described below, thereby preparing a white LED apparatus as shown in FIG. 4. Here, the LED chip used a GaN-base substrate and the emission wavelength had a peak of 390 nm.

[Process 1: Preparation of Inorganic Fluorescent Material-containing Resin]

Inorganic fluorescent material of 250 mg was mixed in silicon-base resin of 1 ml and the mixture was stirred 5 minutes with a revolution of 2000 rpm and a rotation of 800 rpm. Thereafter, the mixture was defoamed by being subjected to vacuuming by a rotary pump.

The inorganic fluorescent material used here was known blue, green, and red fluorescent materials that were mixed with a mixing ratio of 15:65:20 of the blue, green, and red fluorescent materials in this order. The blue and green fluorescent materials had broad emission spectra while the red fluorescent material had an emission spectrum in which few sharp peaks were superimposed.

[Process 2: Coating and Curing of Inorganic Fluorescent Material-containing Resin on LED Chip]

The inorganic fluorescent material-containing resin prepared by Process 1 was injected into a cup electrically connected with a LED chip by a known method. Thereafter, the resin was subjected to heat treatment with 120 degrees for 3 hours to cure the resin.

[Process 3: Preparation of LAMP Type LED]

This was performed in the same manner as that in Process 1 of example 1.

(Test)

Next, with regards to the samples of examples 1 to 2 and comparative example 1 prepared in the manner as described above, the emission spectra were measured.

FIG. 2 shows emission spectra of the white LED apparatus according to example 1 that uses the blue and green inorganic fluorescent materials and the red organic fluorescent material. In comparative example 1, a color rendering index Ra was 83 and a red rating index R9 was 30. It is noted that the color rendering index denotes a value that shows how well colors are rendered in the condition in question compared to a case where the colors are seen in daylight in which natural light is assumed as 100.

By adjusting the mixing ratio or the like of the emission spectrum of the white LED apparatus according to example 2 using the blue and green inorganic fluorescent materials and the red organic fluorescent material, the emission spectrum was almost the same as that of FIG. 2. As in example 1, example 2 showed the color rendering index Ra of 83 and the red rating index R9 of 30.

FIG. 5 shows an emission spectrum of the white LED apparatus according to comparative example 1 that uses the blue, green, and red inorganic fluorescent materials. In comparative example 1, the color rendering index Ra was 75 and the red rating index R9 was 14.

### CONCLUSION

As shown in FIG. 2, example 1 and example 2 showed a broad emission spectrum in the entire range of the visible part. On the other hand, as shown in FIG. 5, comparative example 1 showed a sharp peak in a long wavelength side that is provided by the red fluorescent material. Example 1 and example 2 showed a superior color rendering index than that of comparative example 1. Thus, it was found that the use of the red organic fluorescent material provided high light emission close to that by daylight (high color rendering property).

It was also found that example 1 and example 2 showed almost no change in the spectra even after the lighting for a long time and provided high reliability.

Furthermore, when the white LED light-emitting apparatus according to example 1 is compared to the white LED light-emitting apparatus according to example 2, the white LED light-emitting apparatus according to example 1 showed the color rendering index Ra of 71 and the red rating index R9 of −12 after the lighting for a long time while the white LED light-emitting apparatus according to example 2 showed no change in the color rendering index Ra and in the red rating index R9. This result shows that the white LED apparatus according to example 2 can maintain higher color rendering property and high reliability.

What is claimed is:

1. A semiconductor light emitting apparatus including a packaging member and a light-emitting element mounted in the packaging member, comprising:
a wavelength changer which absorbs the light from the light-emitting element and emits a wavelength-converted light,
wherein the wavelength changer includes inorganic fluorescent material and organic fluorescent material.

2. The semiconductor light emitting apparatus of claim 1, wherein:
an inorganic fluorescent material-containing resin layer including the inorganic fluorescent material is provided at a position to surround the light-emitting element, and
an organic fluorescent material-containing resin layer including the organic fluorescent material is provided on the inorganic fluorescent material-containing resin layer.

3. The semiconductor light emitting apparatus of claim 1, wherein the organic fluorescent material emits red light.

4. The semiconductor light emitting apparatus of claim 1, wherein light emitted from the light-emitting element has a wavelength having a peak of 350 to 420 nm.
